(19) United States
(12) Patent Application Publication
(10) Pub. No.: US 2013/0093556 A1
(43) Pub. Date: Apr. 18, 2013

(54) MULTILAYERED CERAMIC ELECTRONIC COMPONENT AND FABRICATION METHOD THEREOF

(71) Applicant: Bong Sup LIM, Busan (KR)

(72) Inventor: Bong Sup LIM, Busan (KR)

(73) Assignee: SAMSUNG ELECTRO-MECHANICS CO., LTD.

(21) Appl. No.: 13/342,708

(22) Filed: Jan. 3, 2012

(30) Foreign Application Priority Data
Oct. 12, 2011 (KR) 10-2011-0103915

(51) Int. Cl. H01F 5/00; H01B 13/22; H01G 4/12

(52) U.S. Cl. 336/200; 361/321.2; 156/51

(57) ABSTRACT

There are provided a multilayered ceramic electronic component having outer electrodes with excellent corner coverage and adhesive strength, and a fabrication method thereof. Dummy electrodes connected to the outer electrodes are formed on cover areas and an active area of a ceramic main body. A multilayered ceramic electronic component having outer electrodes with excellent corner coverage and adhesive strength can be obtained.

### CROSS-REFERENCE TO RELATED APPLICATIONS

This application claims the priority of Korean Patent Application No. 10-2011-0103915 filed on Oct. 12, 2011, in the Korean Intellectual Property Office, the disclosure of which is incorporated herein by reference.

### BACKGROUND OF THE INVENTION

1. Field of the Invention

The present invention relates to a multilayered ceramic electronic component and a fabrication method thereof, and more particularly, to a multilayered ceramic electronic component having outer electrodes with excellent corner coverage and adhesive strength, and a fabrication method thereof.

2. Description of the Related Art

As ceramic electronic components are miniaturized, it may be difficult to stably coat an outer electrode thereon.

In particular, when an outer electrode is coated through a dipping method, the coverage of corner portions of an electronic component may be degraded in accordance with a reduction in a size thereof.

In forming outer electrodes, when the size of a chip is reduced, the amount of an outer electrode paste applied thereto may be reduced, and the reduction in the amount of the outer electrode paste may result in the outer electrode paste being insufficiently applied to corner portions of the chip.

When the outer electrode paste is not sufficiently applied to the corner portions of the chip, outer electrodes on the corner portions may be easily delaminated therefrom.

Also, in the case that the outer electrodes are not coated on the corner portions of the chip or are delaminated therefrom, a subsequently formed nickel/tin plating layer may not be properly formed, leading to defective mounting of the chip.

### SUMMARY OF THE INVENTION

An aspect of the present invention provides a multilayered ceramic electronic component having outer electrodes with excellent corner coverage and adhesive strength, and a fabrication method thereof.

According to an aspect of the present invention, there is provided a multilayered ceramic electronic component including: a ceramic main body including outer electrodes formed thereon; conductive patterns laminated within the ceramic main body; and first dummy patterns disposed on cover areas of the ceramic main body, electrically separated from the conductive patterns, and exposed outwardly from the ceramic main body.

The first dummy patterns may be disposed within regions of the ceramic main body, covered by the outer electrodes.

The first dummy patterns may be exposed to end faces perpendicular to a length direction of the ceramic main body, in which the outer electrodes are connected thereto and extended therefrom. The first dummy patterns may be exposed to end faces perpendicular to a length direction of the ceramic main body, in which the outer electrodes are connected thereto and extended therefrom and side faces adjacent thereto.

The first dummy patterns may be disposed on at least one of top and bottom faces of the ceramic main body.

The first dummy patterns may have a roughly “└”-like shape or a roughly “[”-like shape, when viewed in a lamination direction of the conductive patterns.

The first dummy patterns may have a quadrangular shape, when viewed in a lamination direction of the conductive patterns.

Each of the first dummy patterns may be formed to be divided into two or more parts.

The first dummy patterns may include a conductive material.

The multilayered ceramic electronic component may further include second dummy patterns disposed on an active area of the ceramic main body, electrically separated from the conductive patterns, and exposed outwardly from the ceramic main body.

The second dummy patterns may be disposed within regions of the ceramic main body, covered by the outer electrodes.

The second dummy patterns may be exposed to end faces perpendicular to a length direction of the ceramic main body, in which the outer electrodes are connected thereto and extended therefrom. The second dummy patterns may be exposed to end faces perpendicular to a length direction of the ceramic main body, in which the outer electrodes are connected thereto and extended therefrom, and side faces adjacent thereto.

The second dummy patterns may have a roughly “└”-like shape, when viewed in a lamination direction of the conductive patterns.

The second dummy patterns may a quadrangular shape, when viewed in a lamination direction of the conductive patterns.

Each of the second dummy patterns may be formed to be divided into two or more parts.

The second dummy patterns may include a conductive metal.

The ceramic main body may include a magnetic material or a dielectric material.

According to another aspect of the present invention, there is provided a method of fabricating a multilayered ceramic electronic component, the method including: forming a first dummy pattern on a ceramic green sheet to prepare a first ceramic green sheet; forming a conductive pattern and a second dummy pattern on another ceramic green sheet to prepare a second ceramic green sheet; laminating the first and second green sheets to prepare a laminate; cutting the laminate such that the first and second dummy patterns are exposed to the outside, and firing the cut laminate; and forming outer electrodes on the fired laminate.

The first dummy pattern may be disposed within regions of the fired laminate, covered by the outer electrodes.

The first dummy pattern may be exposed to an end face perpendicular to a length direction of the fired laminate, in which the outer electrodes are connected thereto and extended therefrom. The first dummy pattern may be exposed to an end face perpendicular to a length direction of the fired laminate, in which the outer electrodes are connected thereto and extended therefrom, and side faces adjacent thereto.

The first dummy pattern may be disposed on at least one of top and bottom faces of the fired laminate.

The first dummy pattern may have a roughly “└”-like shape or a roughly “[”-like shape, when viewed in a lamination direction of the conductive pattern.

The first dummy pattern may have a quadrangular shape, when viewed in a lamination direction of the conductive pattern.

The first dummy pattern may be formed to be divided into two or more parts.

The second dummy pattern may be disposed within regions of the fired laminate, covered by the outer electrodes.

The second dummy pattern may be exposed to an end face perpendicular to a length direction of the fired laminate, in which the outer electrodes are connected thereto and extended therefrom. The second dummy pattern may be exposed to an end face perpendicular to a length direction of the fired laminate, in which the outer electrodes are connected thereto and extended therefrom, and side faces adjacent thereto.

The second dummy pattern may have a roughly “└”-like shape, when viewed in a lamination direction of the conductive pattern.

The first dummy pattern may have a quadrangular shape, when viewed in a lamination direction of the conductive pattern.

The second dummy pattern may be formed to be divided into two or more parts.

The fired laminate may include a magnetic material or a dielectric material.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is an exterior perspective view of a multilayered ceramic electronic component according to an embodiment of the present invention;

FIG. 2 is a schematic view of a ceramic main body of the multilayered ceramic electronic component according to the embodiment of the present invention;

FIG. 3 is an exploded perspective view of the ceramic main body of the multilayered ceramic electronic component according to the embodiment of the present invention;

FIGS. 4A and 4B are plan views of a cover area and an active area of the multilayered ceramic electronic component according to the embodiment of the present invention;

FIGS. 5A through 5F show modified examples of FIG. 4A; and

FIGS. 6A and 6B show modified examples of FIG. 4B.

### DETAILED DESCRIPTION OF THE PREFERRED EMBODIMENT

Embodiments of the present invention will now be described in detail with reference to the accompanying drawings.

The invention may, however, be embodied in many different forms and should not be construed as being limited to the embodiments set forth herein.

Rather, these embodiments are provided so that this disclosure will be thorough and complete, and will fully convey the scope of the invention to those skilled in the art.

In the drawings, the shapes and dimensions of elements may be exaggerated for clarity, and the same reference numerals will be used throughout to designate the same or like components.

A multilayered ceramic electronic component may include a multilayered ceramic capacitor, a chip inductor, chip beads, and the like. Here, a chip inductor will be described as an example, but the present invention is not limited thereto.

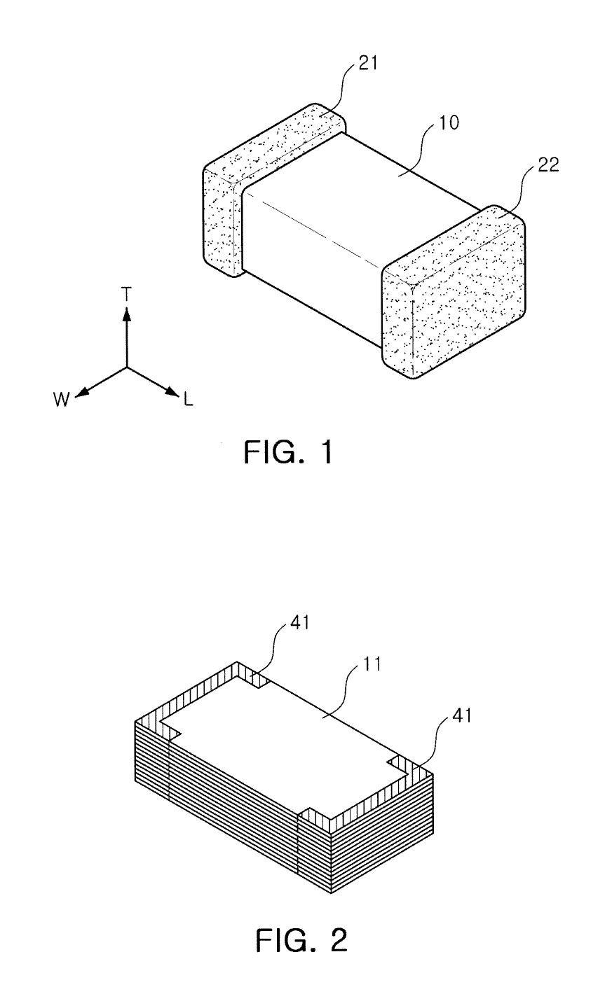

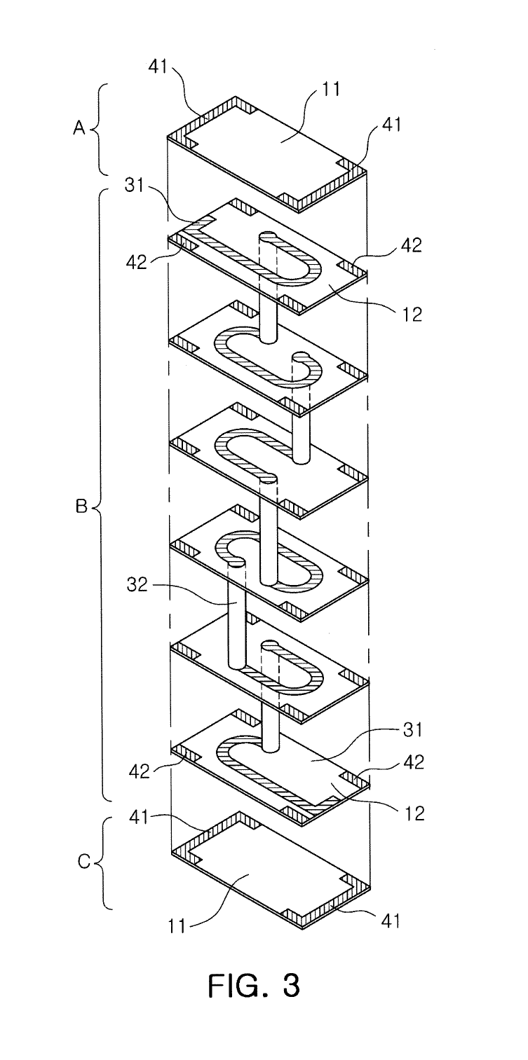

With reference to FIGS. 1 through 4, the multilayered ceramic electronic component according to an embodiment of the present invention may include a ceramic main body 10, outer electrodes 21 and 22 formed on the outside of the ceramic main body 10, and conductive patterns 31 and dummy patterns 41 and 42 laminated within the ceramic main body 10.

In the multilayered ceramic electronic component according to an embodiment of the present invention, it is defined that a direction in which the outer electrodes 21 and 22 are extended and connected to each other may be referred to as a ‘length direction’, a direction in which the conductive patterns 31 are laminated may be referred to as ‘a lamination direction’ or a ‘thickness direction’, and a direction perpendicular to the length direction and the lamination direction may be referred to as a ‘width direction’.

The ceramic main body 10 refers to a body made of a ceramic material, and may have a rectangular shape as shown in FIG. 1.

When the ceramic material is a magnetic material such as nickel-zinc-copper ferrite, or the like, the multilayered ceramic electronic component may be an inductor, and when the ceramic material is a dielectric material using barium titanate as a main material, the multilayered ceramic electronic component may be a capacitor.

Ceramic powder may be mixed in an organic solvent such as ethanol, or the like, and a binder such as PVA or the like, and a plasticizer and the like, are then added therein. Thereafter, the mixture may be mixed and dispersed through ball milling, or the like, to thus fabricate ceramic slurry.

The ceramic slurry is coated and dried on a film such as PET, or the like, through a method such as a doctor blade process, or the like, whereby a plurality of ceramic green sheets are fabricated.

The ceramic main body may be formed by laminating and then sintering the plurality of ceramic green sheets. In the sintered ceramic main body, since the ceramic green sheets are integrated, it may be difficult to discern the boundary therebetween.

The outer electrodes 21 and 22 may be formed on the outside of the ceramic main body 10, and electricity may be applied to the ceramic main body 10 through the outer electrodes 21 and 22 from the outside. In particular, the outer electrodes 21 and 22 may be formed on outer surfaces of the ceramic main body 10 so as to be opposed to each other.

The outer electrodes 21 and 22 may be made of silver (Ag).

The outer electrodes 21 and 22 may be formed through a dipping method or a printing method, and a plated layer (not shown) may be formed on the outer electrodes 21 and 22 in order to allow for installation facilitation.

The conductive patterns 31 may be laminated within the ceramic main body 10.

The conductive patterns 31 may be sequentially connected to form a spiral coil. By forming a spiral coil, the multilayered electronic component may serve as an inductor.

The laminated conductive patterns 31 may be electrically connected to each other by a via, or the like, to form a coil having a spiral structure.

The conductive patterns 31 may be drawn out of the ceramic main body 10 to be connected to the outer electrodes 21 and 22.

After a conductive paste is printed on the ceramic green sheets through a method such as screen printing, or the like, and the printed ceramic green sheets may be laminated to form a structure the conductive patterns 31 laminated therein.

The conductive paste may be fabricated by mixing an organic solvent, or the like, in silver (Ag) powder and then performing ball milling or the like, on the mixture.

The dummy patterns 41 and 42 may include first dummy patterns (denoted by reference numeral 41) and second dummy patterns (denoted by reference numeral 42).

The first dummy patterns 41 may be disposed on cover areas A and C of the ceramic main body and may be exposed outwardly from the ceramic main body 10.

In the specification, ‘first’ and ‘second’ are simply used to discriminate the dummy patterns from other dummy patterns and should not be construed as limiting the scope of the present invention.

The ‘dummy pattern’ may refer to a pattern that is electrically separated from the conductive patterns 31 formed within the ceramic main body 10 and does not directly contribute to the function of the electronic component.

The first dummy patterns 41 may include a conductive metal.

The first dummy patterns 41 may be formed by printing a conductive paste, and may be formed of the same material as that of the conductive patterns 31.

The first dummy patterns 41 may be electrically separated from the conductive patterns 31 formed within the ceramic main body 10, but may be connected to the outer electrodes 21 and 22.

Since the first dummy patterns 41 are connected to the outer electrodes 21 and 22, the adhesive strength between the outer electrodes 21 and 22 and the ceramic main body 10 may be enhanced.

The ceramic main body 10 is made of a ceramic material, and the outer electrodes 21 and 22 are made of a metallic material as a main ingredient, and in this case, the ceramic material and the metallic material are heterogeneous and thus have a strong tendency not to be properly mixed with each other.

Thus, when the outer electrodes 21 and 22 are formed on the ceramic main body 10, the adhesion strength between the ceramic main body 10 and the outer electrodes 21 and 22 may be so weak as to allow them to be easily separated, even through a weak external impact applied thereto.

Thus, the first dummy patterns 41 are formed within the ceramic main body 10 and exposed outwardly from the ceramic main body 10, whereby the outer electrodes 21 and 22 may be additionally connected to the first dummy patterns 41.

The connection between the first dummy patterns 41 and the outer electrodes 21 and 22 is a connection between metals, which has bonding force stronger than that between the ceramic main body 10 and the outer electrodes 21 and 22, and thus, the adhesive strength of the outer electrodes 21 and 22 with respect to the ceramic main body 10 may be enhanced.

The first dummy patterns 41 are disposed on the cover areas A and C of the ceramic main body 10 and may be exposed outwardly from the ceramic main body 10.

The ceramic main body 10 may be formed to be divided into an active area B and the cover areas A and C in the lamination direction of the conductive patterns 31.

The active area B may refer to an area in which the conductive patterns 31 are laminated in the lamination direction of the conductive patterns 31, in the ceramic main body 10.

The active area B is an area exhibiting a main function of the electronic component.

In the case of an inductor, the conductive patterns 31 are laminated and sequentially connected to form a coil structure in the active area B. When current flows through the conductive patterns 31, an induced magnetic field may be formed therein.

In the case of a capacitor, the conductive patterns 31 are alternately laminated with each dielectric layer interposed therebetween in the active area B, such that electric charges may be accumulated between the conductive patterns 31, when voltage is applied thereto from the outside.

The cover areas A and C may refer to areas disposed on and under the active area B.

The cover areas A and C may serve to insulate the active area B from the outside and protect the active area B from an external environment. Namely, the cover areas A and C may prevent external moisture or contaminations from reaching the active area B, thus lengthening a lifespan of a product.

The cover areas A and C may not have the conductive patterns 31 laminated therein.

Namely, a plurality of ceramic green sheets in which the conductive patterns 31 are not formed may be laminated to form the cover areas A and C.

The first dummy patterns 41 may be disposed within regions of the ceramic main body covered by the outer electrodes 21 and 22.

If the first dummy patterns 41 are formed beyond the regions covered by the outer electrodes 21 and 22, the first dummy patterns 41 may be exposed to an external environment and external moisture or a foreign material may infiltrate into the first dummy patterns 41.

In this case, the repeated application of voltage or current may be undertaken, and the ceramic main body 10 may be easily degraded due to moisture or a foreign material which has infiltrated into the first dummy patterns 41.

The first dummy patterns 41 may be exposed to end faces, perpendicular to the length direction of the ceramic main body 10, in which the outer electrodes are connected thereto and extended therefrom.

Since the first dummy patterns 41 and the outer electrodes 21 and 22 are connected, the adhesive strength of the outer electrodes 21 and 22 with respect to the ceramic main body 10 may be enhanced.

Also, the first dummy patterns 41 may be exposed to the end faces of the ceramic main body 10, perpendicular to the length direction thereof and side faces adjacent thereto.

Thus, since the first dummy patterns 41 are also exposed to the side faces adjacent to the end faces perpendicular to the length direction, the adhesive strength of the outer electrodes 21 and 22 with respect to the ceramic main body 10 may be further enhanced.

Also, a corner portion of a connection part to which each of the outer electrodes 21 and 22 and the first dummy pattern 41 are connected may have a roughly “┐”-like shape, so that the adhesive strength of the outer electrodes 21 and 22, with respect to the ceramic main body 10, may be further increased due to the shape of the connection portion.

This is because, when the connection parts of each of the outer electrodes 21 and 22 and the first dummy pattern 41 have the same length, the connection part may have higher resistance to external impacts in a case in which the connection part has a corner portion of a roughly “┐”-like shape.

The first dummy patterns 41 may be disposed on at least one of top and bottom faces of the ceramic main body 10.

In accordance with the miniaturization of electronic products, an electronic component mounted therein is also required to have a reduced size. In this case, a thickness of the outer electrodes 21 and 22 formed on the electronic component is also reduced.

The outer electrodes 21 and 22 may be formed through a dipping method. In this case, when the outer electrodes 21 and 22 are formed to have a reduced thickness, the outer electrodes 21 and 22 may be thinly formed on the corner portions of the ceramic main body 10, rather than the other portions thereof. Extremely, the outer electrodes 21 and 22 may not be formed on the corner portions.

This is because wettability between the ceramic main body 10 and the outer electrodes 21 and 22 is weak.

In order to solve this problem, the first dummy patterns 41 are formed on at least one of the top and bottom faces of the ceramic main body 10 to enhance wettability with the outer electrodes 21 and 22.

The first dummy patterns 41 are formed using a paste containing a conductive metal as a main ingredient, and the outer electrodes 21 and 22 are also formed using a paste containing a conductive metal as a main ingredient, thereby enhancing wettability between the first dummy patterns 41 and the outer electrodes 21 and 22.

The first dummy patterns 41 and the outer electrodes 21 and 22 may be made of the same material.

When the first dummy patterns 41 and the outer electrodes 21 and 22 are made of the same material, wettability between the first dummy patterns 41 and the outer electrodes 21 and 22 may be maximized.

Specifically, the first dummy patterns 41 and the outer electrodes 21 and 22 may be formed by using a silver (Ag)-epoxy paste.

The first dummy patterns 41 are formed on the top and bottom faces of the ceramic main body 10 to enhance wettability with the outer electrodes 21 and 22, such that the outer electrodes 21 and 22 having a sufficient thickness may be formed on the corner portions of the ceramic main body 10.

Even in a case in which the outer electrodes 21 and 22 are not formed on the corner portions of the ceramic main body 10, the first dummy patterns 41 already formed on the top and bottom faces of the ceramic main body 10 may serve as the outer electrodes 21 and 22.

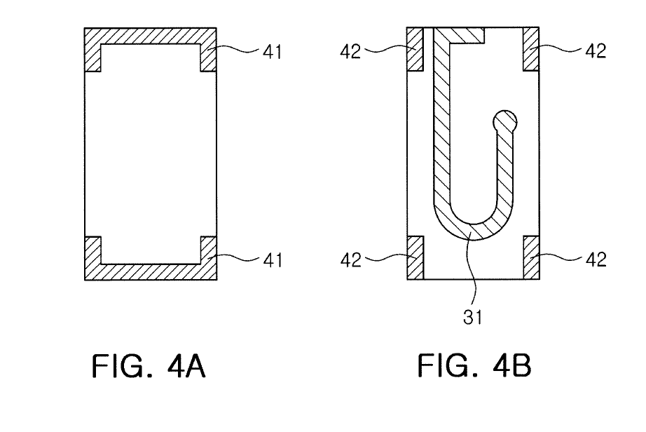

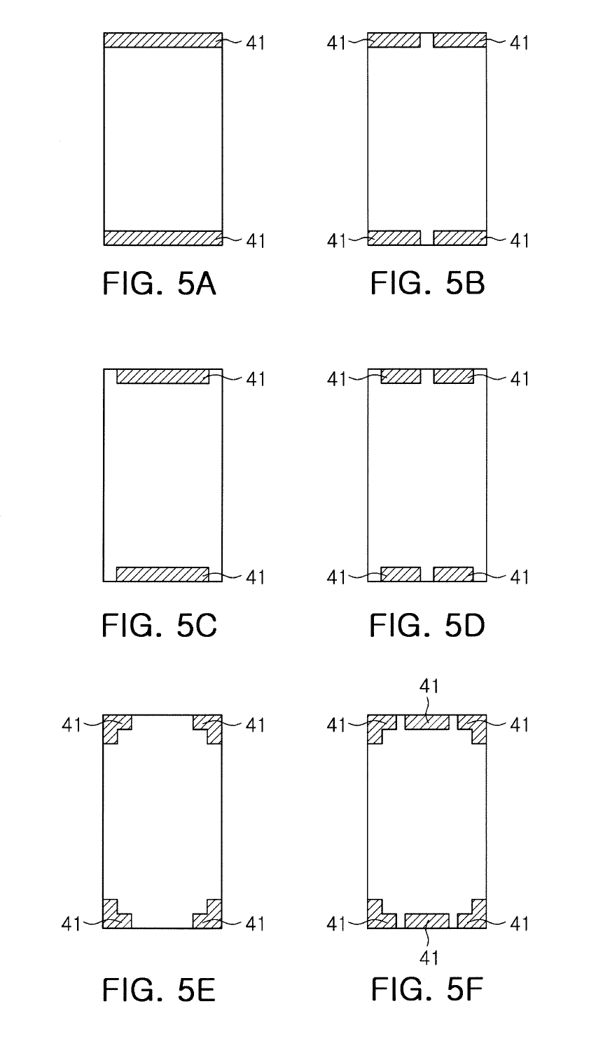

FIG. 4A is a plan view of the first dummy electrode 41, when viewed in the lamination direction of the conductive patterns 31, and FIGS. 5A through 5F show modified examples of the first dummy patterns 41.

With reference to FIG. 4A, when viewed in the lamination direction of the conductive patterns 31, the first dummy patterns 41 may individually have a roughly “[”-like shape.

The first dummy patterns 41 of FIG. 4A, may have the largest area among the dummy patterns shown in FIGS. 4A through 5F.

When the first dummy patterns 41 of FIG. 4A are formed on the top or bottom surface of the ceramic main body 10, wettability with the outer electrodes 21 and 22 may be enhanced, so that the outer electrodes 21 and 22 may be formed to have a sufficient thickness. Here, even if the outer electrodes 21 and 22 are not formed due to fabrication process errors, the first dummy patterns 41 may serve as the outer electrodes 21 and 22.

Such an effect may be maximized when the first dummy patterns 41 and the outer electrodes 21 and 22 are made of the same material.

When the first dummy patterns 41 of FIG. 4A are formed within the respective cover areas A and C of the ceramic main body 10, rather than on the top or bottom surface thereof, since the corner portion of the connection part in which the first dummy pattern 41 and each of the outer electrodes 21 and 22 are connected has a roughly “┐”-like shape, the adhesive strength of the outer electrodes 21 and 22 with respect to the ceramic main body 10 may be effectively enhanced.

With reference to FIG. 5E, the first dummy pattern 41 may have a roughly “└”-like shape and be formed at corner portions of each lamination surface on which the conductive patterns are laminated.

Since the corner portion of the connection part in which the first dummy pattern 41 and each of the outer electrodes 21 and 22 are connected has the roughly “┐”-like shape and forms a right angle, the adhesive strength of the outer electrodes 21 and 22 with respect to the ceramic main body 10 may be effectively enhanced.

With reference to FIGS. 5A and 5C, the first dummy pattern 41 may have a quadrangular shape, when viewed in the lamination direction of the conductive patterns 31.

With reference to FIGS. 5B, 5D, 5E, and 5F, the first dummy pattern 41 may be formed to be divided into two or more parts.

As shown in FIGS. 4A through 5F, the first dummy pattern 41 may be modified to have various shapes. The first dummy pattern 41 may be appropriately adopted according to required characteristics of a product.

The multilayered ceramic electronic component according to the embodiment of the present invention may further include second dummy patterns 42.

The second dummy patterns 42 are disposed on the active area of the ceramic main body 10, electrically separated from the conductive patterns 31, and exposed outwardly from the ceramic main body 10.

Namely, the second dummy patterns 42 may be formed on a layer, on which the conductive patterns 31 are formed. In this case, the second dummy patterns 42 may be electrically separated from the conductive patterns 31 and exposed outwardly from the ceramic main body 10 to be connected to the outer electrodes 21 and 22.

Since the second dummy patterns 42 and the outer electrodes 21 and 22 are connected, the adhesive strength of the outer electrodes 21 and 22 with respect to the ceramic main body 10 may be enhanced.

The second dummy patterns 42 may be disposed within the regions of the ceramic main body covered by the outer electrodes 21 and 22.

When the second dummy patterns 42 are formed beyond the regions covered by the outer electrodes 21 and 22, the second dummy patterns 42 may be exposed to an external environment and contaminated by moisture, a foreign material, or the like. When the repeated application of voltage or current may be undertaken, the ceramic main body 10 may be easily degraded to shorten the lifespan of the electronic component.

The second dummy patterns 42 may be exposed to end faces, perpendicular to the length direction of the ceramic main body 10, in which the outer electrodes 21 and 22 are connected thereto and extended therefrom.

The portion of the second dummy patterns 42 exposed to the end faces of the ceramic body 10, perpendicular to the length direction may be connected to the outer electrodes 21 and 22, and accordingly, the adhesive strength of the outer electrodes 21 and 22 with respect to the ceramic main body 10 may be enhanced.

Also, the second dummy patterns 42 may be exposed to the end faces of the ceramic main body 10, perpendicular to the length direction, and the side faces adjacent thereto.

Due to the fact that the second dummy patterns 42 are additionally exposed to the faces of the ceramic main body 10 to be connected to the outer electrodes 21 and 22, and that a corner portion of a connection part between the second dummy pattern 42 and each of the outer electrodes 21 and 22 has a roughly “┐”-like shape and forms a right angle, the adhesive strength of the outer electrodes 21 and 22 with respect to the ceramic main body 10 may be further enhanced.

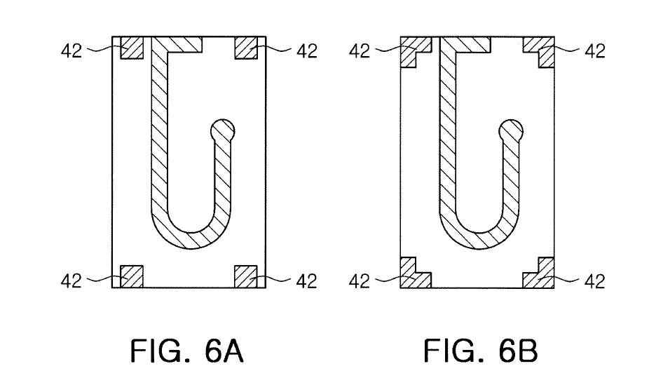

FIG. 4B is a plan view of the second dummy pattern 42, when viewed in the lamination direction of the conductive patterns 31, and FIGS. 6A and 6B show modified examples of the second dummy patterns 42.

With reference to FIG. 4B, the second dummy patterns 42 may be formed on the layer, on which the conductive patterns 31 are formed.

With reference to FIGS. 4B and 6B, the second dummy patterns 42 may be formed at the corner portions of the lamination surface on which the conductive patterns 31 are laminated, and may be exposed to the end faces, perpendicular to the length direction of the ceramic main body 10, and the side faces adjacent thereto.

The corner portion of the connection part between the second dummy pattern 42 and each of the outer electrodes 21 and 22 may have a roughly “┐”-like shape, such that the adhesive strength of the outer electrodes 21 and 22 with respect to the ceramic main body 10 may be enhanced, in a similar manner to that as described above in the case of the first dummy patterns 41.

With reference to FIG. 6B, the second dummy pattern 42 may have a “└”-like shape, when viewed in the lamination direction of the conductive patterns 31.

With reference to FIGS. 4B and 6A, the second dummy pattern 42 may have a quadrangular shape, when viewed in the lamination direction of the conductive patterns 31.

With reference to FIGS. 4B, and 6A and 6B, the second dummy pattern 42 may be formed to be divided into two or more parts.

The ceramic main body 10 may include a magnetic material or a dielectric material.

When the ceramic main body 10 includes a magnetic material, the ceramic electronic component may be an inductor. In this case, the conductive patterns 31 may be sequentially connected to form a spiral coil within the ceramic main body 10.

When the ceramic main body 10 includes a dielectric material, the ceramic electronic component may be a capacitor. In this case, the conductive patterns 31 may be alternately laminated within the ceramic main body 10 and connected to the outer electrodes 21 and 22 having opposite polarities.

Another embodiment of the present invention may provide a method of fabricating a multilayered ceramic electronic component, the method including: forming the first dummy patterns 41 on a ceramic green sheet to prepare a first ceramic green sheet; forming the conductive patterns 31 and the second dummy patterns 42 on another ceramic green sheet to prepare a second ceramic green sheet; laminating the first and second green sheets to prepare a laminate; cutting the laminate such that the first and second dummy patterns 41 and 42 are exposed to the outside, and firing the cut laminate; and forming the outer electrodes 21 and 22 on the fired laminate.

An organic solvent such as ethanol, or the like, a binder such as PVA, or the like, a dispersing agent, and the like, are mixed in ceramic powder to fabricate ceramic slurry, and the ceramic slurry may be applied to a polymer film such as PE, or the like, through a method such as a doctor blade process, or the like, and then dried to fabricate the ceramic green sheet.

The ceramic powder may be a magnetic material such as nickel-zinc-copper ferrite, or the like, or a dielectric material using barium titanate as a main material.

When the ceramic powder is a magnetic material, the electronic component may be an inductor, and when the ceramic powder is a dielectric material, the electronic component may be a capacitor.

The first dummy patterns 41 are formed on the ceramic green sheet to prepare the first ceramic green sheet.

The first dummy patterns 41 may be formed by screen-printing a conductive paste, but the present invention is not limited thereto.

The conductive paste may be a silver (Ag)-epoxy paste. However, the present invention is not limited thereto, and any paste may be used so long as it can provide conductivity.

The conductive patterns 31 and the second dummy patterns 42 may be formed on another ceramic green sheet to prepare the second ceramic green sheet.

The conductive pattern 31 and the second dummy pattern 42 may be formed by screen-printing a conductive paste, but the present invention is not limited thereto.

The conductive paste may be a silver (Ag)-epoxy paste. However, the present invention is not limited thereto, and any paste may be used so long as it can provide conductivity.

The first and second ceramic green sheets may be laminated to prepare the laminate.

First, the first ceramic green sheet and the second ceramic green sheet may be provided in plural. The plurality of first ceramic green sheets may be laminated, the plurality of second ceramic green sheets are laminated thereon, and thereafter, the plurality of first ceramic green sheets may be laminated again thereupon.

The number of the laminated first and second ceramic green sheets may be appropriately selected according to a required standard.

The laminate may be cut such that the first and second dummy patterns 41 and 42 are exposed to the outside, and be then fired. When the first and second dummy patterns 41 and 42 are not exposed to the outside due to fabrication process errors, the sides of the laminate may be polished after the firing so as to expose the first and second dummy patterns 41 and 42 to the outside.

The outer electrodes 21 and 22 may be formed on the fired laminate.

The outer electrodes 21 and 22 may be formed through a dipping method, and the outer electrodes 21 and 22 may be formed to cover the first and second dummy patterns 41 and 42 exposed to the outside.

The first dummy patterns 41 may be disposed within the regions of the ceramic main body covered by the outer electrodes 21 and 22.

The first dummy patterns 41 may be exposed to the end faces, perpendicular to the length direction of the ceramic main body 10, in which the outer electrodes 21 and 22 are connected thereto and extended therefrom.

The first dummy patterns 41 may be exposed to the end faces, perpendicular to the length direction of the ceramic main body 10 and the side faces adjacent thereto.

The first dummy patterns 41 may be disposed on at least one of the top and bottom faces of the ceramic main body 10.

The first dummy patterns 41 may have a roughly “└”-like shape or a roughly “[”-like shape, when viewed in the lamination direction of the conductive patterns 31.

The first dummy patterns 41 may have a quadrangular shape, when viewed in the lamination direction of the conductive patterns 31.

The first dummy patterns 41 may be formed to be divided into two or more parts.

The second dummy patterns 42 may be disposed within the regions of the ceramic main body covered by the outer electrodes 21 and 22.

The second dummy patterns 42 may be exposed to the end faces, perpendicular to the length direction of the ceramic main body 10, in which the outer electrodes 21 and 22 are connected thereto and extended therefrom.

The second dummy patterns 42 may be exposed to the end faces, perpendicular to the length direction of the ceramic main body 10, and the side faces adjacent thereto.

The second dummy patterns 42 may have a roughly “└”-like shape, when viewed in the lamination direction of the conductive patterns 31.

The second dummy patterns 42 may have a quadrangular shape, when viewed in the lamination direction of the conductive patterns 31.

The second dummy patterns 42 may be formed to be divided into two or more parts.

The ceramic main body 10 may include a magnetic material or a dielectric material.

In the method of fabricating a multilayered ceramic electronic component according to another embodiment of the present invention, the matters regarding the first and second dummy patterns 41 and 42, the ceramic main body 10, and the like, are the same as those described in the multilayered ceramic electronic component according to the foregoing embodiment of the present invention.

As set forth above, according to embodiments of the invention, a multilayered ceramic electronic component having a multilayered ceramic electronic component outer electrodes with excellent corner coverage and adhesive strength, and a fabrication method thereof can be obtained.

While the present invention has been shown and described in connection with the embodiments, it will be apparent to those skilled in the art that modifications and variations can be made without departing from the spirit and scope of the invention as defined by the appended claims.

What is claimed is:

1. A multilayered ceramic electronic component comprising:
a ceramic main body including outer electrodes formed thereon;
conductive patterns laminated within the ceramic main body; and
first dummy patterns disposed on cover areas of the ceramic main body, electrically separated from the conductive patterns, and exposed outwardly from the ceramic main body.

2. The multilayered ceramic electronic component of claim 1, wherein the first dummy patterns are disposed within regions of the ceramic main body, covered by the outer electrodes.

3. The multilayered ceramic electronic component of claim 1, wherein the first dummy patterns are exposed to end faces perpendicular to a length direction of the ceramic main body, in which the outer electrodes are connected thereto and extended therefrom.

4. The multilayered ceramic electronic component of claim 1, wherein the first dummy patterns are exposed to end faces perpendicular to a length direction of the ceramic main body, in which the outer electrodes are connected thereto and extended therefrom and side faces adjacent thereto.

5. The multilayered ceramic electronic component of claim 1, wherein the first dummy patterns are disposed on at least one of top and bottom faces of the ceramic main body.

6. The multilayered ceramic electronic component of claim 1, wherein the first dummy patterns have a roughly “└”-like shape or a roughly “[”-like shape, when viewed in a lamination direction of the conductive patterns.

7. The multilayered ceramic electronic component of claim 1, wherein the first dummy patterns have a quadrangular shape, when viewed in a lamination direction of the conductive patterns.

8. The multilayered ceramic electronic component of claim 1, wherein each of the first dummy patterns is formed to be divided into two or more parts.

9. The multilayered ceramic electronic component of claim 1, further comprising second dummy patterns disposed on an active area of the ceramic main body, electrically separated from the conductive patterns, and exposed outwardly from the ceramic main body.

10. The multilayered ceramic electronic component of claim 9, wherein the second dummy patterns are disposed within regions of the ceramic main body, covered by the outer electrodes.

11. The multilayered ceramic electronic component of claim 9, wherein the second dummy patterns are exposed to end faces perpendicular to a length direction of the ceramic main body, in which the outer electrodes are connected thereto and extended therefrom.

12. The multilayered ceramic electronic component of claim 9, wherein the second dummy patterns are exposed to end faces perpendicular to a length direction of the ceramic main body, in which the outer electrodes are connected thereto and extended therefrom and side faces adjacent thereto.

13. The multilayered ceramic electronic component of claim 9, wherein the second dummy patterns have a roughly “└”-like shape, when viewed in a lamination direction of the conductive patterns.

14. The multilayered ceramic electronic component of claim 9, wherein the second dummy patterns have a quadrangular shape, when viewed in a lamination direction of the conductive patterns.

15. The multilayered ceramic electronic component of claim 9, wherein each of the second dummy patterns are formed to be divided into two or more parts.

16. The multilayered ceramic electronic component of claim 1, wherein the ceramic main body includes a magnetic material or a dielectric material.

17. A method of fabricating a multilayered ceramic electronic component, the method comprising:
forming a first dummy pattern on a ceramic green sheet to prepare a first ceramic green sheet;
forming a conductive pattern and a second dummy pattern on another ceramic green sheet to prepare a second ceramic green sheet;
laminating the first and second green sheets to prepare a laminate;
cutting the laminate such that the first and second dummy patterns are exposed to the outside, and firing the cut laminate; and
forming outer electrodes on the fired laminate.

18. The method of claim 17, wherein the first dummy pattern is disposed within regions of the fired laminate, covered by the outer electrodes.

19. The method of claim 17, wherein the first dummy pattern is exposed to an end face perpendicular to a length direction of the fired laminate, in which the outer electrodes are connected thereto and extended therefrom.

20. The method of claim 17, wherein the first dummy pattern is exposed to an end face perpendicular to a length direction of the fired laminate, in which the outer electrodes are connected thereto and extended therefrom, and side faces adjacent thereto.

21. The method of claim 17, wherein the first dummy pattern is disposed on at least one of top and bottom faces of the fired laminate.

22. The method of claim 17, wherein the first dummy pattern has a roughly “└”-like shape or a roughly “[”-like shape, when viewed in a lamination direction of the conductive pattern.

23. The method of claim 17, wherein the first dummy pattern has a quadrangular shape, when viewed in a lamination direction of the conductive pattern.

24. The method of claim 17, wherein the first dummy pattern is formed to be divided into two or more parts.

25. The method of claim 17, wherein the second dummy pattern is disposed within regions of the fired laminate, covered by the outer electrodes.

26. The method of claim 17, wherein the second dummy pattern is exposed to an end face perpendicular to a length direction of the fired laminate, in which the outer electrodes are connected thereto and extended therefrom.

27. The method of claim 17, wherein the second dummy pattern is exposed to an end face perpendicular to a length direction of the fired laminate, in which the outer electrodes are connected thereto and extended therefrom, and side faces adjacent thereto.

28. The method of claim 17, wherein the second dummy pattern has a roughly “└”-like shape, when viewed in a lamination direction of the conductive pattern.

29. The method of claim 17, wherein the second dummy pattern has a quadrangular shape, when viewed in a lamination direction of the conductive pattern.

30. The method of claim 17, wherein the second dummy pattern is formed to be divided into two or more parts.

31. The method of claim 17, wherein the fired laminate includes a magnetic material or a dielectric material.
